(19) United States
(12) Patent Application Publication
(10) Pub. No.: US 2019/0122244 A1
(43) Pub. Date: Apr. 25, 2019

(54) METHODS OF USING A COMPUTING SYSTEM TO MODEL HUMAN BEHAVIOR

(71) Applicant: Synchrony Bank, Draper, UT (US)

(72) Inventors: David H Chau, Stamford, CT (US); Deepak Murthy, Stamford, CT (US); Dimitar Mitkov Dimitrov, Stamford, CT (US)

(21) Appl. No.: 16/165,689

(22) Filed: Oct. 19, 2018

Related U.S. Application Data
(60) Provisional application No. 62/574,696, filed on Oct. 19, 2017.

(51) Int. Cl. G06Q 30/02; G06Q 10/06; G06Q 30/06

(52) U.S. Cl. CPC G06Q 30/0218; G06F 17/28; G06Q 30/0601; G06Q 10/067

(57) ABSTRACT

A method performed by a computing system that has access to a mapping of a plurality of user intentions to a plurality of services. The method includes receiving a communication from a computing device operated by a user and identifying one of the plurality of user intentions based at least in part on the communication. The computing system uses the mapping to identify one of the plurality of services mapped to the identified user intention and provides the identified service.

### CROSS REFERENCE TO RELATED APPLICATION(S)

This application claims the benefit of U.S. Provisional Application No. 62/574,696, filed on Oct. 19, 2017, which is incorporated herein by reference in its entirety.

### BACKGROUND OF THE INVENTION

### Field of the Invention

The present invention is directed generally to methods of using a computing system to model human behavior and treat different people differently based on that model.

### Description of the Related Art

In the past, human merchants interacted with customers. Thus, merchants became familiar with their customers, their needs, and, in some cases, earned their loyalty. This was possible because customers were collocated with the merchants' places of business. However, online shopping has removed this need for both collocation and human interaction. For example, when a customer purchases products online, that customer may never interact with another human being. Instead, the merchant's portion of the transaction may be totally automated. Thus, the modern digital shopping experience isolates customers from merchants and removes opportunities for personalized and engaging shopping experiences. While, in many instances, online shopping is more efficient for customers, it has also created a significant technical problem for merchants, namely, how to create a personal relationship with customers through an online and automated ecommerce site.

Some online ecommerce sites hope to build relationships with customers by allowing customers to earn points based on an amount of money spent. When a customer earns a threshold amount of points, the customer may earn a particular reward. A one-time customer who makes a single expensive purchase will receive the reward while a loyal customer who regularly makes less expensive purchases may not. Thus, such systems do not reward loyalty. Further, such systems may provide inappropriate one-size-fits-all type rewards.

Another method sometimes used by some online ecommerce sites to build relationships is to involve human beings in the shopping experience. For example, some online ecommerce sites provide a human customer service agent for the customer to interact with online. This may be accomplished by using a chat window that the customer may use to interact with the customer service agent. Unfortunately, such chat sessions can be frustrating or unsatisfying. For example, the customer service agent may be rude to the customer or may not know the answer to the customer's question. Further, the customer has no way of knowing if they are interacting with the same customer service agent each time the customer uses the chat. Additionally, if the customer is unhappy with the customer service agent, the merchant may never be notified. Another way in which human beings may be involved in the shopping experience is to offer product reviews provided by past customers. Unfortunately, the reliability of these reviews is questionable. Thus, supplying actual human interaction has its own drawbacks.

Thus, the arm's length nature of ecommerce is a significant technical problem that may not be present in brick and mortar stores where human beings interact with customers. For example, because a merchant's ability to identify loyal customers is severely limited, an online ecommerce site cannot treat different customers differently based their loyalty to the online ecommerce site. Unfortunately, the technical challenge of inadequate human personal interactions can extend to brick and mortar stores as well due to limited staff with the required expertise. Because human beings are somewhat unreliable and inconsistent, when it comes to building customer relationships, using human beings does not fully address the problem. Further, robot managed physical stores have similar challenges because the customer has no option of interacting with human representatives of the merchant. Thus, a need exists for methods of configuring a fully automated online ecommerce site to build a positive relationship with customers. A method that does not rely on using human beings to build this relationship is particularly desirable. The present application provides these and other advantages as will be apparent from the following detailed description and accompanying figures.

### BRIEF DESCRIPTION OF THE SEVERAL VIEWS OF THE DRAWING(S)

FIG. 1 is a block diagram of a system configured to provide a fully automated shopping experience that provides desirable automated interaction with a merchant.

FIG. 2 is a block diagram of exemplary components of a model generating module implemented by a relationship modeling computing system of the system of FIG. 1.

FIG. 3 is a flow diagram of a method performed by the relationship modeling computing system of the system of FIG. 1.

FIG. 4 is a diagram of a hardware environment and an operating environment in which a customer computing device of FIG. 1 may be implemented.

FIG. 5 is a diagram of a hardware environment and an operating environment in which computing devices of the system of FIG. 1 may be implemented.

Like reference numerals have been used in the figures to identify like components.

### DETAILED DESCRIPTION OF THE INVENTION

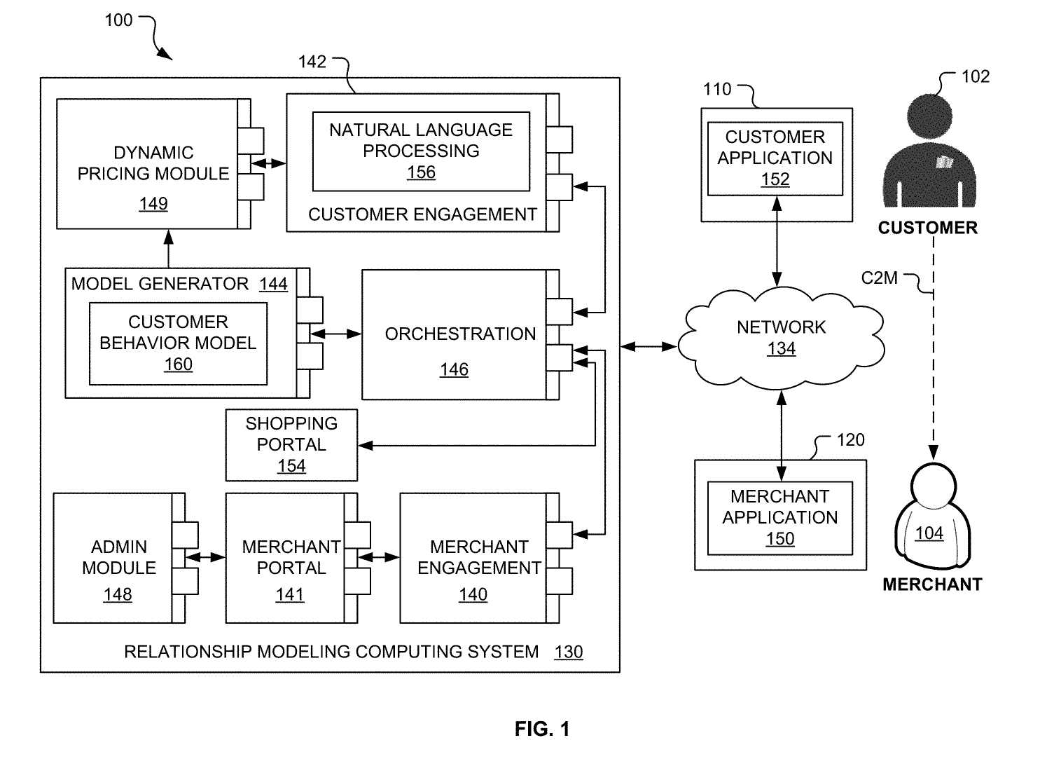

FIG. 1 is block diagram of a system 100 configured to provide a fully automated shopping experience that provides desirable automated interaction with a merchant 104. Thus, the system 100 is configured to create, maintain, and monitor a customer-to-merchant relationship “C2M.” The customer-to-merchant relationship “C2M” may be characterized as how loyal a customer 102 is to the merchant 104. While the customer-to-merchant relationship “C2M” may be characterized as being interpersonal, the merchant 104 need not be an actual human being. Instead, the merchant 104 may be an entity.

The system 100 includes a customer computing device 110 (e.g., a cellular telephone or similar mobile device) operated by the customer 102, a merchant computing system 120 operated by the merchant 104, and a relationship modeling computing system 130. The relationship modeling computing system 130 may be characterized as being a remote computing system with respect to the customer computing device 110 and/or the merchant computing system 120. The system 100 may include any number of customer computing devices each like the customer computing device 110 and each operated by a different customer. However, for ease of illustration, only the single customer computing device 110 has been illustrated and will be described below. Nevertheless, each of the customer computing devices may include substantially identical components and be configured to perform the same functions attributed to the customer computing device 110. Similarly, the system 100 may include any number of merchant computing systems each like the merchant computing system 120 operated by a different merchant. However, for ease of illustration, only the single merchant computing system 120 has been illustrated and will be described below. Nevertheless, each of the merchant computing systems may include substantially identical components and be configured to perform the same functions attributed to the merchant computing system 120.

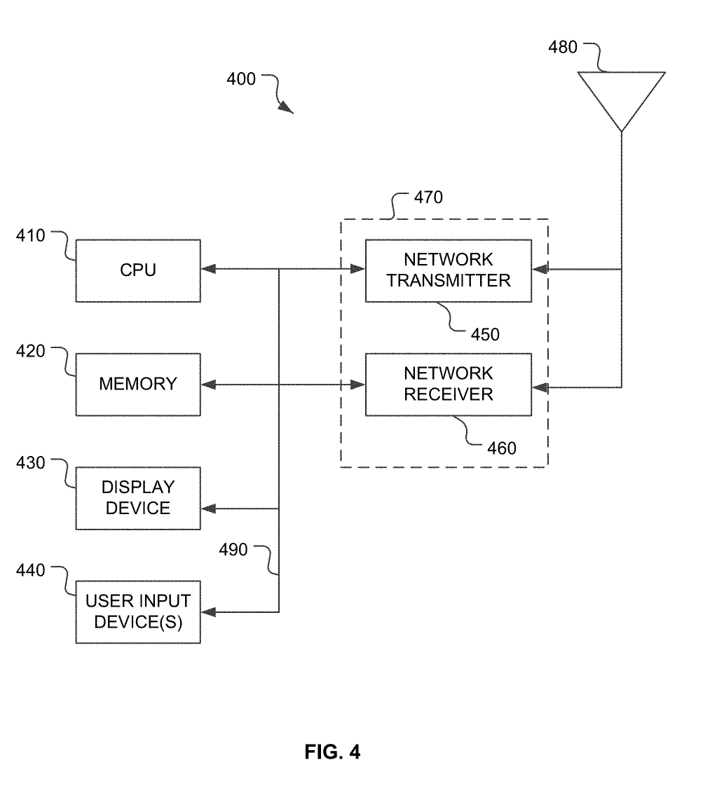

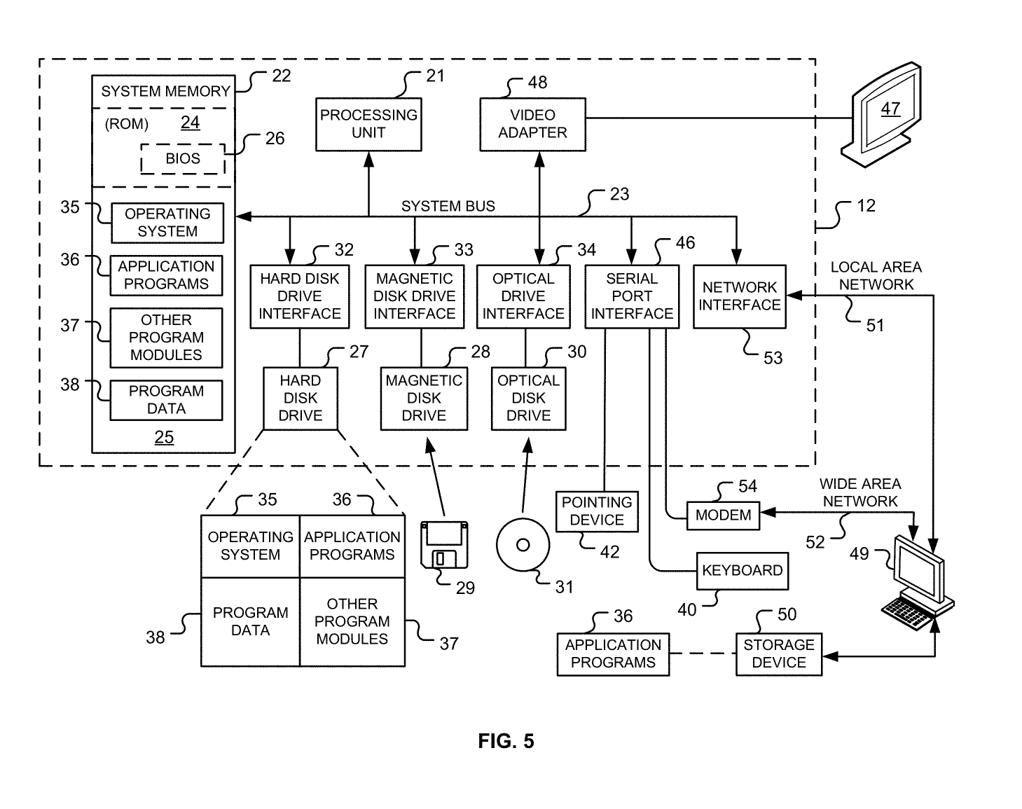

By way of a non-limiting example, the customer computing device 110 may be implemented as a mobile communication device 400 (illustrated in FIG. 4 and described). By way of another non-limiting example, the customer computing device 110 may be implemented as a computing device 12 (illustrated in FIG. 5 and described below). By way of yet another non-limiting example, the merchant computing system 120 and the relationship modeling computing system 130 may each be implemented using one or more computing devices (e.g., each like the computing device 12 illustrated in FIG. 5 and described below).

Referring to FIG. 1, the customer computing device 110 is configured to communicate with the relationship modeling computing system 130 over one or more networks 134 (e.g., a cellular network, the plain old telephone service (“POTS”), and/or the Internet). Similarly, the merchant computing system 120 is also configured to communicate with the relationship modeling computing system 130 over the network(s) 134 (e.g., the Internet, a payment processing network, and the like). Optionally, the customer computing device 110 may be configured to communicate with the merchant computing system 120 over the network(s) 134 (e.g., the cellular network, the POTS, and/or the Internet).

In the embodiment illustrated, the relationship modeling computing system 130 includes a merchant engagement module 140, a merchant portal module 141, a customer engagement module 142, a model generating module 144, an orchestration module 146, an administrative module 148, and a dynamic pricing module 149.

### Merchant Engagement Module

The merchant computing system 120 may implement a merchant application 150 configured to communicate with the merchant engagement module 140 (e.g., via an application programming interface (“API”)). The merchant 104 may receive (e.g., download) the merchant application 150 from the relationship modeling computing system 130.

The merchant engagement module 140 is configured to receive information from the merchant 104 (via the merchant application 150) that is necessary to support the customer-to-merchant relationship “C2M.” For example, the merchant engagement module 140 is configured to receive merchant instructions and map those instructions to one or more merchant services. By way of non-limiting example, the merchant services may include one or more of the following:
1. Setting thresholds for loyalty rewards and dynamic pricing with the dynamic pricing module 149;
2. Setting special shipping or gifting options;
3. Specifying bulk pricing;
4. Specifying referral discounts and promotions;
5. Specifying collective pricing; and
6. Providing product recall notifications.

The merchant engagement module 140 receives merchant portal configuration information from the merchant application 150 and supplies this information to the merchant portal module 141. The merchant portal module 141 uses the merchant portal configuration information to configure and operate an automated ecommerce or shopping portal 154 whereat the merchant 104 offers one or more products for sale to the customer 102. The shopping portal 154 includes a conventional shopping cart module (not shown) that the customer 102 may use to purchase one or more products from the merchant 104.

By way of non-limiting examples, the merchant portal configuration information may include one or more of the following:
1. Product inventory;
2. Any reviews of the products;
3. Base pricing of the products;
4. Applicable surcharges for the products; and
5. Acceptable forms of payment.
   The merchant portal configuration information may also be used to setup any notifications, specify fulfillment methods, and conduct settlements (e.g., with the customer 102).

The merchant engagement module 140 may request that the merchant 104 supply the merchant portal configuration information (e.g., product characteristics) in a manner that encourages pattern recognition and machine learning. The merchant portal configuration information (e.g., range of prices, promotions, product reviews, etc.) encourages the customer 102 to make informed product purchase decisions on the shopping portal 154. The merchant portal configuration information may include setup information that the merchant engagement module 140 uses to establish secure integration with the merchant computing system 120.

The merchant engagement module 140 may be characterized as being a hub for analytics. These analytics may be used by the merchant 104 to determine how effective the merchant 104 has been at attracting customers to the shopping portal 154.

### Merchant Portal Module

The merchant portal module 141 is configured to generate the shopping portal 154 based at least in part on the merchant portal configuration information. The merchant engagement module 140 is configured to provide communication between the merchant application 150 and the merchant portal module 141. The customer engagement module 142 and the orchestration module 146 are configured to provide communication between the customer application 152 and the shopping portal 154. The customer 102 uses the customer application 152 to access the shopping portal 154. The customer 102 may visit the shopping portal 154 and use the shopping portal 154 to purchase one or more of the products offered for sale on the shopping portal 154.

### Customer Engagement Module

The customer computing device 110 implements a customer application 152 configured to communicate with the customer engagement module 142 (e.g., via an API). The customer 102 may receive (e.g., download) the customer application 152 from the relationship modeling computing system 130.

The customer engagement module 142 may be characterized as implementing a conversational user experience (“UX”) that presents one or more automated interfaces to the customer 102 (via the customer application 152) and learns about the customer 102 based on information supplied by the customer 102 to the automated interface(s). From the viewpoint of the customer 102, the customer application 152 provides all or nearly all communication between the customer 102 and the merchant 104.

For example, the customer 102 uses the customer application 152 to shop on the shopping portal 154 that is generated by the merchant portal module 141. Shopping may include searching the product inventory, reviewing any available reviews of the products located during the search, and purchasing one or more products (e.g., adding one or more products the customer's shopping cart and providing a form of payment). As the customer 102 shops, the customer application 152 sends interaction information to the customer engagement module 142. By way of non-limiting examples, the interaction information may include one or more of the following:

1. Physical location of the customer 102;

2. Product(s) located while searching;

3. Products added to shopping cart;

4. Products purchased; and

5. Payment information.

The customer engagement module 142 may include an optional natural language processing module 156. The optional natural language processing module 156 may include an Artificial Intelligence (“AI”) engine configured to use natural language processing to conduct automated conversations with the customer 102. In other words, the natural language processing module 156 may automatically prompt the customer 102 for one or more responses and automatically understand the intention(s) of the customer 102 based on the response(s). The prompts may be played and/or displayed by the customer application 152 using the customer computing device 110. The customer 102 may provide the responses by speaking or typing the responses into the customer application 152 using the customer computing device 110. Examples of such prompts and response thereto are provided in Table A below:

TABLE A

| Prompt | Response |
|---|---|
| Why are you interested in | One or more sentences expressing |
| the product (e.g., what is your need | the way the product is likely to |
| for the product)? | be used |
| What are the characteristics of the | One or more product |
| product (including pricing) you are | characteristics |
| searching for and planning on | |
| purchasing | |
| Do you have any questions for the | Questions for the merchant 104. |
| merchant 104 regarding the product | |
| and its match to your requirements? | |
| Have you reviewed products | Reviews of products purchased |
| purchased from the merchant 104 | previously. |
| previously? | |

The customer engagement module 142 has a mapping of each of a plurality of predetermined customer intentions to one or more phrases or sentences. For example, the optional natural language processing module 156 may include such a mapping. In such embodiments, the optional natural language processing module 156 uses this mapping to determine the customer intention(s) based on the response(s). By way of non-limiting example, the predetermined customer intention(s) may include one or more of the following:
1. Search products;
2. Add product(s) to shopping cart;
3. Purchase product(s) in shopping cart; and
4. Provide a form of payment.
5. Browse products to meet specific needs and/or wants;
6. Assess if the product(s) meets the needs and/or wants of the customer 102;
7. Examine if the product or a related product meets some anticipated wants of the customer 102;
8. Determine if the product(s) are within their expected range of price, branding, and quality;
9. Assess if the merchant 104 is reputable and will deliver the promise (e.g., will the product be as described on the product information pages); and
10. Return the product if it is defective or if there is an intolerable deviation from the description on the product information pages.

The customer engagement module 142 maps each of the predetermined customer intentions to one or more available customer services (e.g., each implemented via an API). For example, the available customer services may include a real-time search for products, prices, and/or reviews. By way of non-limiting example, the available customer services may include one or more of the following:
1. Provide product information (e.g., pictures, specifications, shipping constraints, etc.);
2. Provide product pricing;
3. Provide product reviews created by other customers;
4. Initiate complaint;
5. Request return and refund;
6. Request servicing of product (e.g., assembling, repair, etc.);
7. Search products;
8. Add product(s) to shopping cart; and
9. Purchase product(s) in shopping cart.

For example, the optional natural language processing module 156 might prompt the customer 102, “How can I help you?” In response, the customer 102 might reply “I would like to buy item A.” The customer engagement module 142 (e.g., the natural language processing module 156) recognizes item A as a product of the merchant 104 and maps the phrase “I would like to buy” to the predetermined customer intention to add the product (namely, item A) to the shopping cart. The customer engagement module 142 maps this customer intention to the customer service of adding item A to the shopping cart. The customer engagement module 142 directs the customer application 152 to the shopping portal 154 and places item A in the shopping cart. Next, the natural language processing module 156 prompts the customer 102, “Would you like to continue shopping or purchase the item(s) in your shopping cart?” If the customer 102 responds “purchase the item,” the customer engagement module 142 (e.g., the natural language processing module 156) maps the phrase “purchase the item” to the predetermined customer intention to purchase the product(s) in shopping cart and the customer engagement module 142 maps the predetermined customer intention to the corresponding customer service and directs the shopping portal 154 to check out the customer 102. If the customer 102 responds “continue shopping,” the customer engagement module 142 (e.g., the natural language processing module 156) maps the phrase “continue shopping” to the predetermined customer intention to search products and may prompt the customer 102, “What would you like to shop for?” As mentioned above, the prompts and responses thereto may be presented over voice and/or digital data channels. Thus, the natural language processing module 156 may include voice recognition. By way of a non-limiting example, the natural language processing module 156 may be implemented as an Intelligent Voice Automation (“IVA”) system. An example of a suitable IVA system is a SmartAction IVA that may be purchased from SmartAction of El Segundo, California, which operates a website at www.smartaction.ai. Additional non-limiting examples of suitable IVA systems that may be used to implement the natural language processing module 156 include api.ai, Amazon Lex, and NextlT.

When the customer 102 accesses the customer application 152, the customer engagement module 142 may invoke the natural language processing module 156, which automates the merchant portion of conversations between the customer 102 and the merchant 104. These conversations provide the customer 102 with an opportunity to receive simulated merchant attention with regard to their product purchase. These conversations also provide the relationship modeling computing system 130 (which operates as a stand in for the merchant 112) with a chance to get to know the customer 102 for future, and continued personalization. The customer engagement module 142 allows the relationship modeling computing system 130 to determine customer intention(s) and use this information to increase engagement between the customer 102 and the merchant 104.

### Model Generating Module

The orchestration module 146 supplies information received from the merchant engagement module 140 and/or the customer engagement module 142 to the model generating module 144. The model generating module 144 uses this information to generate a customer behavior model 160 that describes the customer-to-merchant relationship “C2M.” The customer behavior model 160 includes one or more relationship aspects. For example, the customer behavior model 160 may include a loyalty score or the loyalty score may be determined based on the customer behavior model 160. By way of a non-limiting example, the loyalty score may include three values indicating whether the customer 102 is very loyal, moderately loyal, or not yet loyal to the merchant 104. Alternatively, the loyalty score may include more or fewer values.

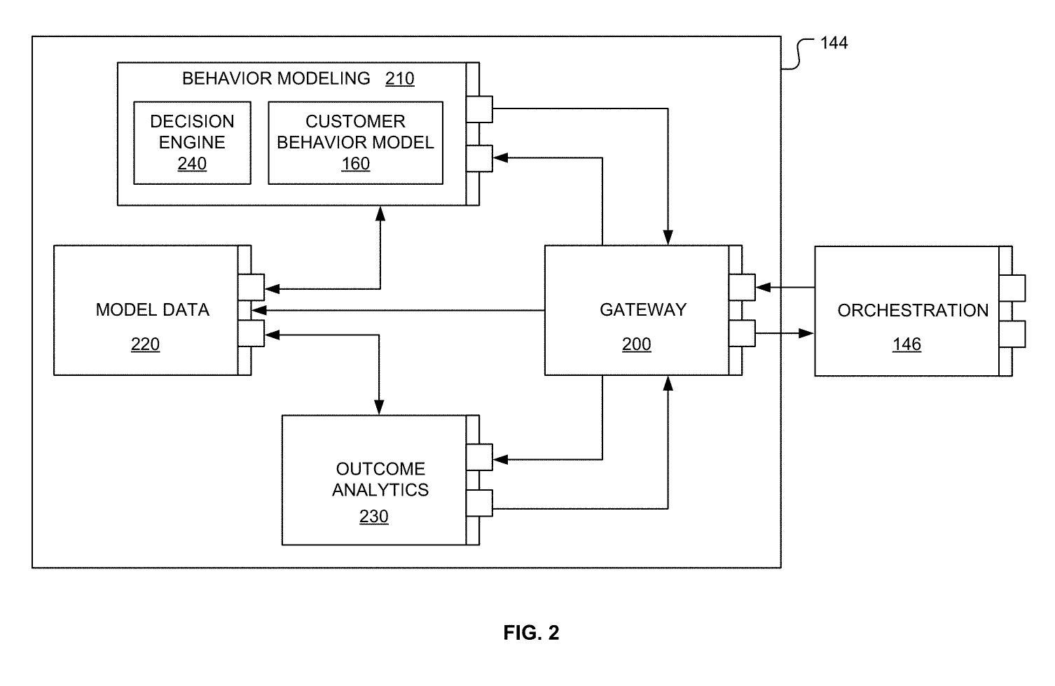

Referring to FIG. 2, the model generating module 144 may include a gateway module 200, a behavior modeling module 210, model data 220, and an outcome analytics module 230.

The gateway module 200 is configured to communicate with the orchestration module 146. The gateway module 200 may expose, via an API, each of the behavior modeling module 210, the model data 220, and the outcome analytics module 230. In such embodiments, the orchestration module 146 invokes these APIs as necessary to perform various tasks.

The gateway module 200 receives and optionally processes messages from the orchestration module 146. This processing may include duplicating information or messages. The gateway module 200 forwards the processed messages to the behavior modeling module 210, the model data 220, and/or the outcome analytics module 230. The gateway module 200 arbitrates across the other modules by categorizing events specific to these modules. For example, the gateway module 200 routes messages that include post-sales information and/or events (e.g., product purchases, refund requests, and the like) to the outcome analytics module 230 for analytics. On the other hand, the gateway module 200 routes messages that include pre-sales information and/or events (e.g., browsing patterns, requests for product information, requests for product reviews, and the like) to the behavior modeling module 210. The gateway module 200 is also configured to receive messages from the behavior modeling module 210 and/or the outcome analytics module 230 and forward these messages to the orchestration module 146.

The outcome analytics module 230 generally analyzes post-sale data to gain insight into future sales potential. Results obtained by the outcome analytics module 230 may be stored in the model data 220 and used by the behavior modeling module 210. The outcome analytics module 230 may analyze historical data received from the gateway module 200 and/or stored in the model data 220 and identify trends for completion of sales and fulfillment of orders. For example, the outcome analytics module 230 may review historical sales data with respect to the customer 102 and generate a trend value for the customer that is stored in the model data 220. By way of another non-limiting example, the outcome analytics module 230 may analyze data for multiple customers to obtain shopping trends and store them in the model data 220.

The outcome analytics module 230 may identify opportunities for cross-selling and advise the merchant 104 with regard to product positioning. For example, the outcome analytics module 230 may identify related products or products that are likely to be purchased together. By way of non-limiting examples, the outcome analytics module 230 could notify the merchant 104 that customers who purchased motherboards also purchased CPUs or that customers who purchase jeans are also very likely to purchase shoes. The outcome analytics module 230 may use this information to assist the merchant 104 in planning the best way to gain customer attention when the customer 102 visits the merchant 104.

The behavior modeling module 210 generally analyzes pre-sales data and focuses on priorities of the customer 102 and the merchant 104. The behavior modeling module 210 generates the customer behavior model 160. As mentioned above, the customer behavior model 160 includes one or more relationship aspects (e.g., the loyalty score). The behavior modeling module 210 includes a decision engine 240 that is configured to be trained using training data to determine the loyalty score and/or other relationship aspects of the customer behavior model 160 based on a particular set of input variables. As is apparent to those of ordinary skill in the art, training data includes sets of sample values of the input variables and a corresponding known or desired result for each set. Values of at least a portion of the input variables may be stored in the model data 220 and retrieved therefrom by the model generating module 144. By way of a non-limiting example, the model generating module 144 may determine the loyalty score based the values of one or more of the following input variables:
1. The trend value determined for customer interactions with the merchant 104;
2. History of customer interactions with the merchant 104;
3. A net promoter score earned by the customer 102 with regard to the merchant 104;
4. Increased likelihood for positive sentiment in social forums;
5. Merchant referrals; and
6. Repeat sales.

The net promoter score is a measure of how the customer 102 rates the merchant 104 when requested to do so. The net promoter score is used to gauge customer experience with respect to the merchant's products and/or services. Typically, this customer experience obtained through surveys and polling. For example, a poll might ask “on a scale of 0-10, how likely are you to recommend this merchant to your social circle?” The response to this poll helps the merchant 104 improve the merchant's products and/or services based on customer feedback. The net promoter score may be determined based at least in part on the customer's response. Thus, a high net promoter score means the customer 102 recommended the merchant 104 to others with the least hesitation.

As mentioned above, values of at least a portion of the input variables may be stored in the model data 220 and retrieved therefrom by the model generating module 144. For example, the model generating module 144 may send a request to the model data 220. The request may include a customer identifier (e.g., a primary account number), a location, and a period. In response to the request, the model data 220 may locate information associated with the customer 102 and send that information to the model generating module 144. By way of non-limiting examples, the information may include one or more of the following:
1. Recent transactions between the customer 102 and the merchant 104;
2. Recent browsing by the customer 102;
3. Recent interactions between the customer 102 and the merchant 104;
4. Key purchases made by the customer 102 from the merchant 104; and
5. Recent events involving the customer 102 and the merchant 104.

The decision engine 240 may include an AI engine and/or machine learning algorithm(s) configured to be trained using the training data to determine the relationship aspect(s) of the customer behavior model 160 based on the set of input variables. By way of non-limiting examples, the decision engine 240 may be implemented using TensorFlow, MXNet, SciKit-Learn, Keras, Theano, Amazon AWS Machine learning module, and the like.

The decision engine 240 may implement one or more methods (e.g., derived in game theory) that increase or maximize returns for merchants (e.g., the merchant 104) and satisfaction in the purchase experience for customers (e.g., the customer 102). As a non-limiting example, the decision engine 240 may implement a min-max algorithm of game theory. This algorithm may maximize customer loyalty while minimizing risk to the merchant 104.

The behavior modeling module 210 may optimize customer loyalty. The customer behavior model 160 provides insight into the ‘voice of the customer.’ This insight is helpful in understanding the needs and preferences of customers. The customer behavior model 160 may be analyzed to determine metrics and/or parameters that may be used by the decision engine 240 to predict shopping preferences of customers.

The behavior modeling module 210 may reduce risk to the merchant 104 of a loss of in short-term profitability as a result of discounts, promotions, etc. The customer behavior model 160 may be analyzed to determine the best offer that can be made to customers within the merchant's risk tolerance.

The model data 220 stores the customer's loyalty history, which may include recent transactions between the customer 102 and the merchant 104, recent browsing by the customer 102, recent interactions between the customer 102 and the merchant 104, key purchases made by the customer 102 from the merchant 104, and recent events involving the customer 102 and the merchant 104. By way of a non-limiting example, the model data 220 may be implemented as a database. The model data 220 may also store social media interactions of the customer 102 with respect to the merchant 104, geolocation data, analytics contrasting physical and online shopping, and other data that preserve models of customer behavior. The model data 220 may store history of the customer's affinity for the merchant 104. For example, the model data 220 may store one or more of the following:
1. Frequency of visits by the customer 102 to the merchant's retail outlets and/or the shopping portal 154;
2. Amount of time the customer 102 spent browsing for products on the shopping portal 154;
3. Measure of referrals to the merchant 104 by the customer 102;
4. Key purchases by the customer 102 from the merchant 104; and
5. Frequency of visits by the customer 102 to the shopping portal 154 during sales and promotional events.

### Orchestration Module

The orchestration module 146 receives the interaction information and optionally the customer intention(s) from the customer engagement module 142. As mentioned above, the customer engagement module 142 uses the customer intention(s) to connect the customer application 152 to customer services that support the customer intention(s). The customer engagement module 142 may access the customer service(s) through the orchestration module 146. The customer service(s) may produce one or more customer results that are forwarded to the orchestration module 146. The orchestration module 146 may send the customer result(s) to the customer engagement module 142, which forwards the result(s) to the customer application 152. By way of a non-limiting example, the customer result(s) may include one or more of the following:
1. A short list of products that best match the customer intention(s);
2. Prompts that seek to clarify the customer intention(s);
3. Detailed reviews and merchant recommendations for products listed on the shopping portal 154;
4. Automatically generated responses to questions posed to the merchant 104; and
5. Options for pricing and purchasing.

The orchestration module 146 receives the merchant portal configuration information from the merchant engagement module 140. The orchestration module 146 uses the merchant portal configuration information to initiate data access from a proxy for the merchant computing system 120 and to support product purchase and checkout processes. Optionally, the orchestration module 146 may use the merchant portal configuration information to notify merchant of individual dynamic pricing requests that were sent to the dynamic pricing module 149 by the customer engagement module 142.

As mentioned above, the merchant engagement module 140 connects the merchant application 150 to the merchant services. The merchant engagement module 140 may access the customer service(s) through the orchestration module 146. The merchant service(s) may produce one or more merchant results that are forwarded to the orchestration module 146. The orchestration module 146 may send the merchant result(s) to the merchant engagement module 140, which forwards the result(s) to the merchant application 150. By way of a non-limiting example, the merchant result(s) may include one or more of the following:
1. Notifications that the customer 102 is initiating conversational interactions;
2. Customer intention(s) (e.g., searching for products and purchasing products), which enables the merchant 104 to position products effectively to suit the needs of the customer 102;
3. Analytics of customer shopping trends to ensure that the merchant 104 can proactively stock the merchant's wares and guarantee fulfillment;
4. The loyalty score of the customer 102, which may the merchant 104 implement future promotional offers; and
5. Product purchase experience of the customer 102, which may help enable future simplification.

### Administration Module

The administrative module 148 manages the customer and merchant services. Optionally, the administrative module 148 may allow the merchant 104 to offer products for individual dynamic pricing (e.g., via the dynamic pricing module 149), which includes offering the products at a special price or providing a promotion or other offer. The administrative module 148 may also permit the issuers of credit cards or equivalent financial instruments (e.g., financial instruments that can be managed via a digital wallet) to establish reasonable limits for a level of acceptable risk and to control fraud.

### Dynamic Pricing Module

As mentioned above, the decision engine 240 determines the loyalty score for the customer 102. The loyalty score is used by the dynamic pricing module 149 to determine a special price (e.g., a best offer) for one or more products when purchased by the customer 102. The special price is determined based on parameters set by the merchant 104 using the merchant engagement module 140. For example, the merchant 104 may specify that a particular loyalty score is eligible for a particular price (e.g., a very loyal customer may be eligible for a discount of no more than 10% and a not yet loyal customer may be eligible for a discount of only 3%).

The dynamic pricing module 149 may also use the loyalty score to determine whether the customer 102 is eligible for a promotion or other offer. For example, a very loyal customer may be eligible for a gift item (e.g., a fragrance) in the merchant's inventory with a purchase of a particular product (e.g., an item of clothing).

The customer engagement module 142 is configured to send a request to the dynamic pricing module 149. The request includes an identifier of the customer 102 and may optionally identify one or more products the customer 102 wishes to purchase. In response to the request, the dynamic pricing module 149 obtains the customer's loyalty score and determines whether the customer 102 is eligible for a special price, promotion, or other offer. The dynamic pricing module 149 notifies the customer engagement module 142 of the results of this determination. The customer engagement module 142 may notify the customer application 152, which may display (using the customer computing device 110) the special price, promotion, or other offer for which the customer 102 is eligible. The customer engagement module 142 also applies the special price, promotion, or other offer, if applicable, when the customer engagement module 142 triggers the customer service(s).

### Method

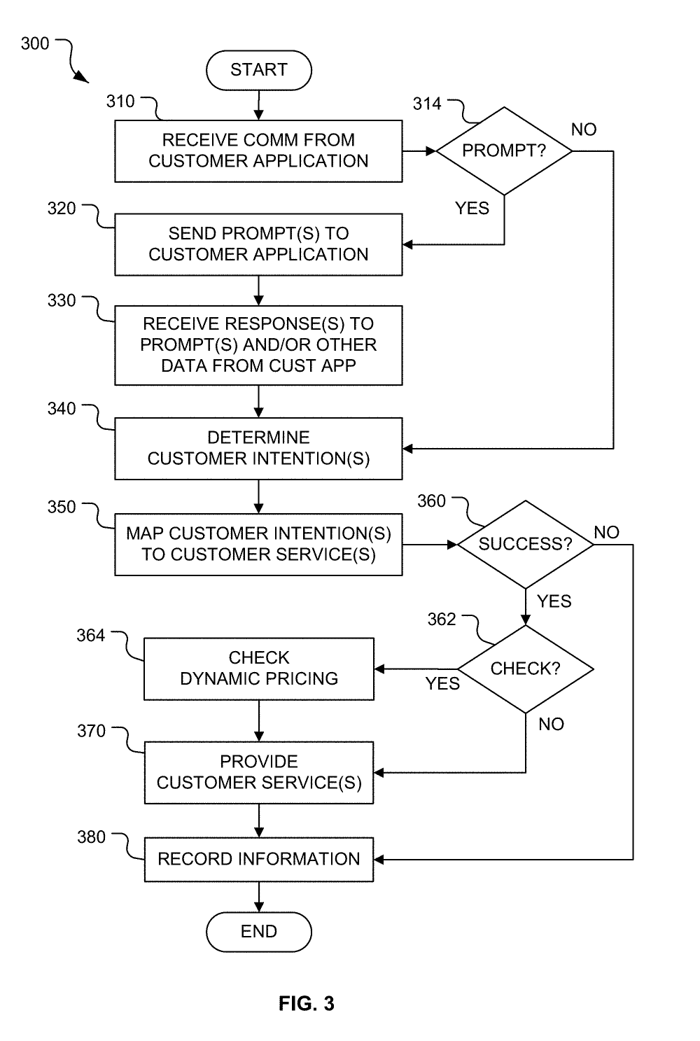

FIG. 3 is a flow diagram of a method 300 performed by the relationship modeling computing system 130. Referring to FIG. 1, in first block 310 (see FIG. 3), the customer engagement module 142 receives a communication from the customer application 152. For example, the customer engagement module 142 may receive a search request for skis.

Referring to FIG. 3, in decision block 314, the customer engagement module 142 (see FIG. 1) determines whether any prompts are necessary to determine the customer intention(s). The decision in decision block 314 is “YES” when one or more prompts are necessary to determine the customer intention(s). Otherwise, the decision in decision block 314 is “NO.”

When the decision in decision block 314 is “NO,” the relationship modeling computing system 130 (see FIG. 1) advances to block 340.

When the decision in decision block 314 is “YES,” in block 320, the customer engagement module 142 (see FIG. 1) sends one or more prompts to the customer application 152 (see FIG. 1). Referring to FIG. 1, the customer application 152 displays or plays the prompt(s) to the customer 102 who provides one or more written or spoken natural language responses to the prompt(s). The customer application 152 sends the response(s) to the customer engagement module 142.

In block 330 (see FIG. 3), the customer engagement module 142 receives the response(s), which the optional natural language processing module 156 may interpret.

In block 340 (see FIG. 3), the customer engagement module 142 (e.g., the natural language processing module 156) identifies the predetermined customer intention(s) based on the interpreted response(s) and optionally forwards the predetermined customer intention(s) to the orchestration module 146. For example, the customer engagement module 142 may identify a customer intention to buy a particular pair of skis from the merchant 104.

In block 350 (see FIG. 3), the customer engagement module 142 attempts to map the predetermined customer intention(s) to one or more customer services.

Referring to FIG. 3, in decision block 360, the customer engagement module 142 (see FIG. 1) determines whether the customer intention(s) were successfully mapped to any customer services. The decision in decision block 360 is “YES” when the customer intention(s) mapped to at least one customer service. Otherwise, the decision in decision block 360 is “NO.”

When the decision in decision block 360 is “NO,” the customer engagement module 142 (see FIG. 1) advances to block 380.

On the other hand, when decision in decision block 360 is “YES,” in decision block 362, the customer engagement module 142 (see FIG. 1) determines whether the predetermined customer service(s) are of the type that might trigger a special price, promotion, or other offer. The decision in decision block 362 is “YES,” when the predetermined customer service(s) might trigger a special price, promotion, or other offer. For example, if the predetermined customer service(s) include purchasing the product(s) in the shopping cart, the decision in decision block 362 is “YES.” On the other hand, the decision in decision block 362 is “NO,” when the predetermined customer service(s) do not trigger a special price, promotion, or other offer. For example, if the predetermined customer service is search products, the decision in decision block 362 is “NO.”

When the decision in decision block 362 is “YES,” in block 364, the customer engagement module 142 (see FIG. 1) checks with the dynamic pricing module 149 (see FIG. 1) to determine if the customer 102 (see FIG. 1) is eligible for a special price, promotion, or other offer. Referring to FIG. 1, the dynamic pricing module 149 may obtain the customer behavior model 160 or at least one of its relationship aspects (e.g., the loyalty score) from the model generating module 144. The dynamic pricing module 149 uses the customer behavior model 160 or the relationship aspect(s) to determine whether the customer 102 is eligible for a special price, promotion, or other offer. If the loyalty score indicates the customer 102 is a very loyal customer, the dynamic pricing module 149 may inform the customer engagement module 142 that the customer 102 is eligible for a discount. In block 364, the customer engagement module 142 may apply any special price, promotion, or other offer for which the customer 102 is eligible. Then, the customer engagement module 142 advances to block 370.

Referring to FIG. 3, when the decision in decision block 362 is “NO,” the customer engagement module 142 (see FIG. 1) advances to block 370.

In block 370, the customer engagement module 142 (see FIG. 1) provides the customer service(s) mapped to the customer intention(s). Referring to FIG. 1, for example, in block 370 (see FIG. 3), the customer 102 may use the customer application 152 to place an order for the particular pair of skis with the merchant 104. Thus, in block 370 (see FIG. 3), the customer 102 may add skis to the customer's shopping cart, purchase the skis in shopping cart, and provide a form of payment. Optionally, in block 364 (see FIG. 3), the dynamic pricing module 149 may determine the loyalty score associated with the customer 102 (in the customer behavior model 160) qualifies the customer 102 for a discount. This discount is provided to the customer 102 in block 364 or block 370 (see FIG. 3).

In block 380 (see FIG. 3), the relationship modeling computing system 130 records information in the model data 220. For example, if applicable, the relationship modeling computing system 130 may record information related to the service(s) provided in block 370 (see FIG. 3). By way of another example, the relationship modeling computing system 130 may record the customer intention(s) and/or response(s). Then, the method 300 terminates.

Optionally, in block 310 (see FIG. 3), the customer application 152 may send the location of the customer 102 to the relationship modeling computing system 130. Optionally, in block 370 (see FIG. 3), the relationship modeling computing system 130 may determine whether the customer 102 is physically close to a product (e.g., the pair of skis). If the customer 102 is physically close to the product, the relationship modeling computing system 130 may send a message to the customer application 152, which may alert the customer 102 so that the customer 102 may purchase the product.

### Mobile Communication Device

FIG. 4 is a functional block diagram illustrating the mobile communication device 400 that may be used to implement the customer computing devices (e.g., the customer computing device 110) of FIG. 1. By way of non-limiting examples, referring to FIG. 4, the mobile communication device 400 may be implemented as a cellular telephone, a tablet computer, and the like. The mobile communication device 400 includes a central processing unit (CPU) 410. Those skilled in the art will appreciate that the CPU 410 may be implemented as a conventional microprocessor, application specific integrated circuit (ASIC), digital signal processor (DSP), programmable gate array (PGA), or the like. The mobile communication device 400 is not limited by the specific form of the CPU 410.

The mobile communication device 400 also contains a memory 420. The memory 420 may store instructions and data to control operation of the CPU 410. The memory 420 may include random access memory, ready-only memory, programmable memory, flash memory, and the like. The mobile communication device 400 is not limited by any specific form of hardware used to implement the memory 420. The memory 420 may also be integrally formed in whole or in part with the CPU 410.

The mobile communication device 400 also includes conventional components, such as the display device 430 and one or more user input devices 440 (e.g., buttons, a keypad, a keyboard, and the like). These are conventional components that operate in a known manner and need not be described in greater detail. The display device 430 may be implemented as a touch display or touchscreen configured to receive user input (e.g., responses to prompts, communication with the customer application 152, and the like). By way of non-limiting examples, the display device 430 is operable to display the prompts, the shopping portal 154 (see FIG. 1), displays generated by the customer application 152, information sent to the customer application 152 by the customer engagement module 142 or the orchestration module 146, and the like.

The memory 420 stores computer executable instructions that when executed by the CPU 410 cause the CPU 410 to generate the screens and interfaces described above and displayed by the display device 430. Referring to FIG. 1, the memory 420 (see FIG. 4) also stores computer executable instructions that when executed by the CPU 410 implement the customer application 152. Such instructions may be stored on one or more non-transitory computer-readable media. Returning to FIG. 4, other conventional components found in wireless communication devices, such as a USB interface, Bluetooth interface, camera/video device, infrared device, and the like, may also be included in the mobile communication device 400. For the sake of clarity, these conventional elements are not illustrated in the functional block diagram of FIG. 4.

The mobile communication device 400 also includes a network transmitter 450 such as may be used by the mobile communication device 400 for normal network wireless communication with the network(s) 134 (see FIG. 1), such as with a base station (not shown) of a cellular network. FIG. 4 also illustrates a network receiver 460 that operates in conjunction with the network transmitter 450 to communicate with the network(s) 134 (see FIG. 1), such as with the base station (not shown) of the cellular network. In a typical embodiment, the network transmitter 450 and network receiver 460 are implemented as a network transceiver 470. The network transceiver 470 is connected to an antenna 480. Operation of the network transceiver 470 and the antenna 480 for communication with the network(s) 134 (see FIG. 1) is well-known in the art and need not be described in greater detail herein.

Referring to FIG. 4, the mobile communication device 400 may also include a conventional geolocation module (not shown) operable to determine the current location of the mobile communication device 400.

The various components illustrated in FIG. 4 are coupled together by a bus system 490. The bus system 490 may include an address bus, data bus, power bus, control bus, and the like. For the sake of convenience, the various busses in FIG. 4 are illustrated as the bus system 490.

The memory 420 may store instructions executable by the CPU 410. The instructions may implement portions of the method 300 illustrated in FIG. 3. Such instructions may be stored on one or more non-transitory computer or processor readable media.

### Computing Device

FIG. 5 is a diagram of hardware and an operating environment in conjunction with which implementations of the one or more computing devices of the system 100 may be practiced. The description of FIG. 5 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments (e.g., cloud computing platforms) where tasks are performed by remote processing devices that are linked through a communications network. In a distributed computing environment, program modules may be located in both local and remote memory storage devices.

The exemplary hardware and operating environment of FIG. 5 includes a general-purpose computing device in the form of the computing device 12. Each of the computing devices mentioned above, including those illustrated in FIG. 1 (e.g., the customer computing device 110, the merchant computing system 120, and the relationship modeling computing system 130), may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, a blade computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, and/or RAM 25, including the operating system 35, one or more application programs 36, other program modules 37, program data 38, and any of the modules discussed above (e.g., the merchant engagement module 140, the merchant portal module 141, the customer engagement module 142, the model generating module 144, the orchestration module 146, the administrative module 148, the dynamic pricing module 149, customer application 152, and the merchant application 150). A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 5 include a local-area network (LAN) 51 and a wide-area network (WAN) 52. Such networking environments are commonplace in offices, enterprise-wide computer networks, intranets and the Internet. The network(s) 134 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the method 300 illustrated in FIG. 3) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

The invention claimed is:

1. A method comprising:
receiving, by a computing system, a communication from a computing device operated by a user, the computing system having access to a mapping of a plurality of user intentions to a plurality of services;
identifying, by the computing system, one of the plurality of user intentions based at least in part on the communication;
using, by the computing system, the mapping to identify one of the plurality of services mapped to the identified user intention; and
providing, by the computing system, the identified service.

2. The method of claim 1, wherein the mapping is a first mapping,
the computing system has access to a second mapping that maps user statements to the plurality of user intentions, and
the computing system uses the second mapping to identify the identified user intention based on one or more statements included in the communication.

3. The method of claim 2, wherein the computing system uses natural language processing to interpret the one or more statements included in the communication, and
the computing system identifies the identified user intention based on the interpreted one or more statements.

4. The method of claim 1, wherein the communication is a second communication, and the method further comprises:
receiving, by the computing system, a first communication before the second communication; and
sending, by the computing system, a prompt to the computing device operated by the user in response to the first communication, the second communication being received in response to the prompt.

5. The method of claim 1, further comprising:
determining, by the computing system, that the identified service triggers a special price, promotion, or offer;
determining, by the computing system, whether the user is eligible for the special price, promotion, or offer; and
applying, by the computing system, the special price, promotion, or offer when the user is determined to be eligible.

6. The method of claim 5, wherein the special price, promotion, or offer is a discount, and the method further comprises:
obtaining, by the computing system, a score associated with the user, the score having either a first, second, or third value, the first value indicating the user is very loyal, the second value indicating the user is moderately loyal, the third value indicating the user is not yet loyal, the computing system determining the user is eligible for the discount when the score has the first value, the computing system determining the user is ineligible for the discount when the score has the second or third value.

7. The method of claim 6, further comprising:
determining, by the computing system, the score based at least in part on a measure of how the user rates a merchant when requested to do so.

8. The method of claim 6, further comprising:
determining, by the computing system, the score based at least in part on past interactions between the user and a merchant.

9. The method of claim 8, further comprising:
generating, by the computing system, a shopping portal whereat the merchant offers one or more products for sale, wherein the identified service is a purchase of at least one of the one or more products, the purchase having a price, the discount being a reduction in the price; and
recording, by the computing system, interactions between the user and the shopping portal as interactions between the user and the merchant.

10. The method of claim 1, wherein the communication is received from a customer application executing on the computing device operated by the user, and the method further comprises:
downloading, by the computing system, the customer application to the computing device operated by the user before the communication is received.

11. A system comprising:
a relationship modeling computing system comprising at least one first processor connected to first memory storing a first map and first instructions, the first map mapping a plurality of user intentions to a plurality of services, the first instructions being executable by the at least one first processor and, when executed by the at least one first processor, causing the at least one first processor to:
receive a communication over a network from a user computing device operated by a user;
identify one of the plurality of user intentions, as an identified user intention, based at least in part on the communication;
use the first map to identify, as an identified service, which of the plurality of services is mapped to the identified user intention; and
provide the identified service.

12. The system of claim 11, further comprising:
the user computing device, which comprises at least one second processor connected to second memory storing second instructions, the second instructions being executable by the at least one second processor and, when executed by the at least one second processor, causing the at least one second processor to:
receive user input; and
send the communication, to the relationship modeling computing system, based at least in part on the user input.

13. The system of claim 12, wherein the first instructions, when executed by the at least one first processor, cause the at least one first processor to generate a shopping portal whereat a merchant offers one or more products for sale, and the system further comprises:
a merchant computing device operated by a merchant and connected to the relationship modeling computing system by the network, the merchant computing device comprising at least one third processor connected to third memory storing second instructions, the third instructions being executable by the at least one third processor and, when executed by the at least one third processor, causing the at least one third processor to provide information related to the one or more products to the relationship modeling computing system for use thereby to generate when generating the shopping portal.

14. The system of claim 13, wherein the identified service is a purchase of at least one of the one or more products for a price, the first memory stores a score associated with the user, and the first instructions, when executed by the at least one first processor, cause the at least one first processor to:
determine that the identified service triggers a discount offered by the merchant, the discount being a reduction in the price;
determine whether the user is eligible for the discount based at least in part on the score; and
apply the discount when the user is determined to be eligible.

15. The system of claim 14, wherein the first memory stores a measure of how the user rates the merchant when requested to do so, and
the first instructions, when executed by the at least one first processor, cause the at least one first processor to determine the score based at least in part on the measure.

16. The system of claim 14, wherein the first instructions, when executed by the at least one first processor, cause the at least one first processor to:
record interactions between the user and the shopping portal as interactions between the user and the merchant, and
determine the score based at least in part on the record interactions between the user and the merchant.

17. The system of claim 11, wherein the first memory stores a second map that maps user statements to the plurality of user intentions, and
the first instructions, when executed by the at least one first processor, cause the at least one first processor to use the second map to identify the identified user intention based on one or more statements included in the communication.

18. The system of claim 17, wherein the first instructions comprise a natural language processing module,
the natural language processing module, when executed by the at least one first processor, cause the at least one first processor to interpret the one or more statements included in the communication, and
the first instructions, when executed by the at least one first processor, cause the at least one first processor to identify the identified user intention based on the interpreted one or more statements.

19. The system of claim 18, wherein the communication is a second communication, and the first instructions, when executed by the at least one first processor, cause the at least one first processor to:
receive a first communication before the second communication; and
send a prompt to the user computing device in response to the first communication, the second communication being received in response to the prompt.
